(19) United States
(12) Patent Application Publication
(10) Pub. No.: US 2007/0233495 A1
(43) Pub. Date: Oct. 4, 2007

(54) Partially automated technology for converting a graphical interface to a speech-enabled interface

(75) Inventors: Ciprian Agapi, Lake Worth, FL (US); Felipe Gomez, Weston, FL (US); Kevin M. Horowitz, Plantation, FL (US); James R. Lewis, Delray Beach, FL (US); Baiju D. Mandalia, Boca Raton, FL (US); Brent D. Metz, Delray Beach, FL (US); David E. Reich, Jupiter, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/391,825

(22) Filed: Mar. 29, 2006

(51) Int. Cl. G10L 21/00

(52) U.S. Cl. 704/270

(57) ABSTRACT

A method for constructing speech elements within an interface can include a step of identifying a visual interface having multiple visual elements. Visual selectors can be presented proximate each of the visual elements. The visual selectors can permit a user to input a speech control type for the associated visual element. For each presented visual selector, a speech element having a speech control type specified in the visual selector can be automatically generated.

### BACKGROUND

1. Field of the Invention

The present invention relates to the field of software development, and, more particularly, to an interactive software development tool where speech-enabled interface elements are generated from graphical user interface elements based upon user provided criteria and automated processes.

2. Description of the Related Art

Increasingly, computing devices utilize speech-enabled interfaces in addition to or instead of conventional graphical user interfaces. Industries are increasing becoming automated and employees are being asked to conduct a multitude of real-world tasks while interacting with a computing device. Multimodal interfaces having speech and graphical interface modes have proven to be a boon to permit these employees to simultaneously perform the real world task and computer interactions using a mode of interaction most convenient for this dual activity. For example, a check-out clerk can speak a command for a computing device into a microphone while packing purchased items for a consumer. That same clerk can utilize a graphical interface to interact with the computing device while speaking with consumers.

Another reason that speech-enabled interfaces are increasing being used relates to the proliferation of mobile computing devices that have limited or inconvenient input/output peripherals. This is particularly true for mobile, embedded, and wearable computing devices. For example, many smart phones include a touch screen GUI and a speech interface. The speech interface can receive spoken input that is automatically converted to text and placed in an application, such as an email application or a word processing application. This spoken input mechanism can be significantly easier for a user than attempting to input a textual message using a touch screen input mechanism associated with a GUI mode of the device. Additionally, the mobile device may be utilized in an environment where a relative small screen (due to the mobile nature of a portable device) is difficult to read or in a situation where reading a display screen is overly distracting. In these situations, textual output can be converted into speech and audibly presented to a user.

Despite a widespread use of computing devices having speech interaction modes, a large percentage of applications lack a speech modality for interactions. This is perhaps most noticeable with Web pages, which are generally configured for complex GUI interactions and configured to be rendered in a visual browser. Even though many mobile devices are Web enabled, users are often unable to access desired sites from these mobile devices because the visual elements are not able to be rendered on the limited screen of the mobile device and because the desired site lacks a speech interaction mode. Similarly, although many voice browsers exist that permit telephone users to access Web content, few Web pages are designed for clean speech-based interactions.

The two common approaches to convert GUI applications to speech user interface (SUI) applications involve designing SUI applications from scratch and the use of transcoding technologies. Writing a SUI from scratch can be costly and time consuming. Transcoding a SUI directly from a GUI has typically resulted in SUI code including many errors, which can be annoying to users of automatically and dynamically generated SUI. Alternatively, results of the automatically generated SUI code can be modified by a developer in a post generation stage of a SUI development effort. These post generation stage modifications can be time consuming, costly, and can result in relatively low quality SUIs (depending on time expended in the post generation stage).

### SUMMARY OF THE INVENTION

A software tool that interactively generates speech-enabled interfaces from graphical user interfaces (GUIs) using some automated processes and at least one pre-generation, designer-specified choice. More specifically, a design interface can graphically guide a process of creating speech-enabled elements from corresponding GUI elements. In the design interface, a visual selector can be placed next to each GUI element that is to be converted to a speech user interface (SUI) element. The placing of a visual selector next to each associated GUI element can occur automatically and/or manually.

A designer can specify a speech control type to which the GUI element is to be converted within the visual selector. In one embodiment, this selection can be made from a list of available speech control types, which can each correspond to a reusable dialog component (RDC) or other code mechanism that facilitates a generation of the speech-enabled element. The visual selector can be initially populated with a default speech control type and/or with a speech control type determined using a transcoding technology. After a designer has adjusted the values within the visual selectors, a speech user interface (SUI) can be automatically created. This interface can be a new speech-only interface as well as a multimodal interface including both the GUI elements and the speech-enabled elements. Additionally, the GUI and the new interface can both be implemented in a markup language renderable by a browser. In one embodiment, a call flow interface or view can be available from within the design interface that can provide a developer with known call flow design features that promote the production of high-quality speech-enabled interfaces from the automatically generated SUI code.

The present invention can be implemented in accordance with numerous aspects consistent with material presented herein. For example, one aspect of the present invention can include a method for constructing speech elements within an interface. The method can include a step of identifying a visual interface having multiple visual elements. Visual selectors can be presented proximate each of the visual elements. The visual selectors can permit a user to input a speech control type for the associated visual element. For each presented visual selector, a speech element having a speech control type specified in the visual selector can be automatically generated.

Another aspect of the present invention can include a software development application including a visual design window, a selector enabled window, and a SUI element generation engine. The visual design window can be configured to designate visual elements of a visual interface and to automatically generate programmatic instructions associated with designated visual elements. The selector enabled window can graphically display GUI elements of the visual design window. At least a portion of the displayed elements can be associated with displayed visual selectors. Each visual selector can permit a user of the software development application to input a speech control type for the associated GUI element. The SUI element generation engine can automatically generate SUI elements corresponding to each GUI element that is associated with a visual selector. Each generated SUI element can have a speech control type specified by the visual selector.

Still another aspect of the present invention can include a graphical user interface including a window for rendering markup written in a visual markup language. Visual selectors can be graphically rendered in the window even though the visual selectors are not specified in the visual markup language. Each visual selector can correspond to a visual element displayed in the window. Each visual selector can permit a user to designate a speech control type. For each visual selector, a speech-enabled element can be automatically generated that has the designated speech control type. The automatically generated markup can be written in a speech-enabled markup language that is created for each of the speech-enabled elements.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a flow diagram of a system that generates speech user interface (SUI) elements from graphical user interface (GUI) elements in accordance with an embodiment of the inventive arrangements disclosed herein.

FIG. 2 is a diagram showing graphical user interfaces (GUIs) of a partially automated software development tool for converting GUI elements into SUI elements in accordance with an embodiment of the inventive arrangements disclosed herein.

### DETAILED DESCRIPTION OF THE INVENTION

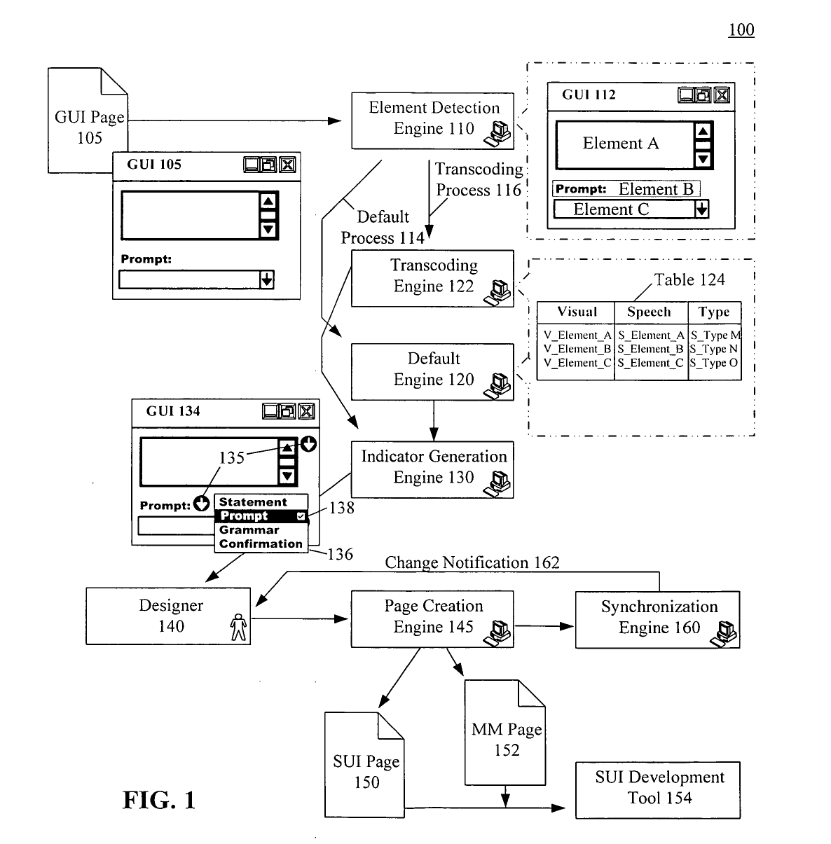

FIG. 1 is a flow diagram of a system 100 that generates speech user interface (SUI) elements from graphical user interface (GUI) elements in accordance with an embodiment of the inventive arrangements disclosed herein. System 100 utilizes a partially automated or designer-assisted conversion process, where visual selectors are presented next to a corresponding visual element within a GUI software design interface. A designer can input the type of speech control that the visual element is to be converted into by specifying a control within the visual selector. SUI code including programmatic instructions for the selector-designated SUI speech control type can be automatically generated. The generated SUI code can be modified using other tools of a software design interface, such as a call flow development tool.

In system 100, a GUI page 105 can be sent to an element detection engine 110. The GUI page 105 can be a page written in a markup language that is able to be rendered in a browser. For example, the GUI page 105 can be written in Extensible Markup Language (XML) or Hypertext Markup Language (HTML). GUI page 105 is not limited in this regard, however, and can include a page, section, or view, of an application written in any code language, such as JAVA, C++, VISUAL BASIC, and the like.

The element detection engine 110 can automatically detect one or more visual objects contained within the GUI page 105 that are able to be converted to speech-enabled objects. In one embodiment, text, list boxes, radio buttons, and the like can be convertible visual objects while pictures and video clips may be non-convertible objects for purposes of the element detection engine 110.

GUI 112 shows how three visual objects of GUI 105 can be automatically identified by the element detection engine 110. Specifically, a text area can be identified as Element A, a prompt as Element B, and a selection list as Element C. A default establishment process 114 or a transcoding process 116 can be performed once the elements have been identified. Process 114 and/or 116 can initially establish a speech control type for each SUI element.

Speech control types can include, but are not limited to, greetings, prompts, statements, grammars, comments, confirmations, and the like. Different grammars can be associated with the different speech control types for which input is requested. For example, Element A can be associated with a context-free grammar that is to receive a user dictation, while Element C can be associated with a context-dependent grammar having words/phrases consisting of those words/phrases that appear in the graphical list box.

The default engine 120 can be used when default establishment process 114 is to be used. The default engine 120 can perform some relatively simple substitutions to estimate a speech control type. For example, all text appearing in a markup tag for title can be converted onto a greeting control type by the default engine 120. Similarly, all visual elements appearing in the body of a markup document having text messages under a certain character length can be considered prompts by the default engine 120.

The transcoding engine 122 can be used when system 100 is configured for transcoding process 116. The transcoding engine 122 can execute complex algorithms and/or heuristics that automatically convert visual programmatic instructions to speech-enabled programmatic instructions. For example, the transcoding engine 122 can convert XML or HTML markup to VoiceXML markup. The transcoding engine 122 can be implemented as any of a variety of fashions using numerous existing technologies and tools. For example, the transcoding engine 122 can include International Business Machine's (IBM's) WEBSPHERE TRANSCODING PUBLISHER.

Regardless of whether the default engine 120 or the transcoding engine 122 is used, a visual element to speech element table 124 can be constructed. In table 124, each identified visual element can be associated with a speech element having a speech control type. For example, visual Elements A, B, and C can be associated with speech Elements A, B, and C. Speech Element A can have corresponding speech control Type M, speech Element B can correspond to Type N, and speech Element C can correspond to Type O. In one arrangement, each speech control type can correspond to a reusable dialog component, such as those available through the WEBSPHERE VOICE TOOLKIT.

An indicator generation engine 130 can utilize table 124 to construct GUI 134, which can be presented to designer 140. GUI 134 can be included within a software design tool used by designer 140. GUI 134 can include a visual selector 135 positioned near associated visual elements. A selection window 136 can be provided for each visual selector 135. The selection window 136 can include a list 138 of speech control types.

In one embodiment, one type in the list 138, such as a prompt control type, can be pre-selected based upon table 124. In another contemplated embodiment, the visual selectors can be initially presented without default settings. In such an embodiment, the default engine 120 and/or the transcoding engine 122 may be unnecessary.

Designer 140 can view and modify these control types. Designer 140 can also delete visual selectors 135 from GUI 134 when no speech element is to be generated for a corresponding visual element. Additionally, designer 140 can add new visual selectors within GUI 134 and associate the new selectors with visual elements not detected by element detection engine 110. In one embodiment, system 100 can be configured so that the designer 140 can explicitly associate all visual selectors with visual elements. In that configuration, the element detection engine 110 is not necessary.

Once the designer 140 has manipulated GUI 134, the page creation engine 145 can be used to generate SUI page 150 and/or multimodal page 152. Either of these pages 150 and/or 152 can be further processed through a SUI development tool 154. For example, the SUI development tool 154 can be a developer interface that enables call flow features to be graphically added to the SUI page 150 and/or the multimodal page 152.

The synchronization engine 160 can be utilized to synchronize elements of a generated page 150 or 152 with GUI page 105. That is, whenever a change is made to either the GUI page 105 or an associated speech-enabled page 150 or 152, a change notification 162 can be automatically conveyed to designer 140. In one embodiment, the notification 162 can include an ability to automatically update elements in the non-changed version.

The synchronization engine 160 and other functions of system 100 can be integrated within numerous development frameworks. In one embodiment, system 100 functionality can utilize a STRUTS framework, which utilizes a Model-View-Controller architecture based upon servlets and JAVASERVER PAGES (JSP) based technologies.

In another embodiment, system 100 functionality can be part of an ECLIPSE Integrated Development Environment. In still another embodiment, the system 100 can be part of a Multi-Device Authoring Technology (MDAT) based development environment.

It should be appreciated that the various components shown in FIG. 100 are shown for illustrative purposes only and that other embodiments having derivatives of the illustrated components are contemplated herein. For example, in one contemplated embodiment, the element detection engine 110, the transcoding engine 122, and the indicator generation engine 130 can be combined into a single component having the functionality discussed for the composite components. In another contemplated arrangement, the SUI development tool 154, GUI 134, and the engines 111, 122, 120, 130, 145, and/or 160 can be integrated into a single software development package.

It should be noted that system 100 can be part of a solution that automatically produces a complete choice application solution. A complete voice application solution can include features like potential fallback to DTMF, comprehensive help messages, and automated speech code generation from within a graphical development environment.

The solution can include numerous existing technologies, such as those included within by IBM's CONVERSATION FLOW BUILDER (aka, CALL FLOW BUILDER, or CFB), RATIONAL APPLICATIONS DEVELOPER (RAD), JAVA SERVER FACES, TRANSCODING PUBLISHER, and the like.

Additional technologies useful for creating a complete voice solution can include technologies specified in U.S. Patent Application 2005/0234255 (Method and System for Switching between Prototype and Real Code Production in a Graphical Call Flow Builder), U.S. Patent Application 2005/0234725 (Method and System for Flexible Usage of a Graphical Call Flow Builder), U.S. Patent Application 2005/0108015 (Method and System for Defining Standard Catch Styles for Speech Application Code Generation), and U.S. Patent Application 2005/0081152 (Help Option Enhancement for Interactive Voice Response Systems). The technologies detailed in these applications are not intended to be a comprehensive list of technologies that can be integrated with the present invention, but are instead referenced to substantiate that the current disclosure can be combined with presently existing technologies by one of ordinary skill in the art to produce a complete voice application solution.

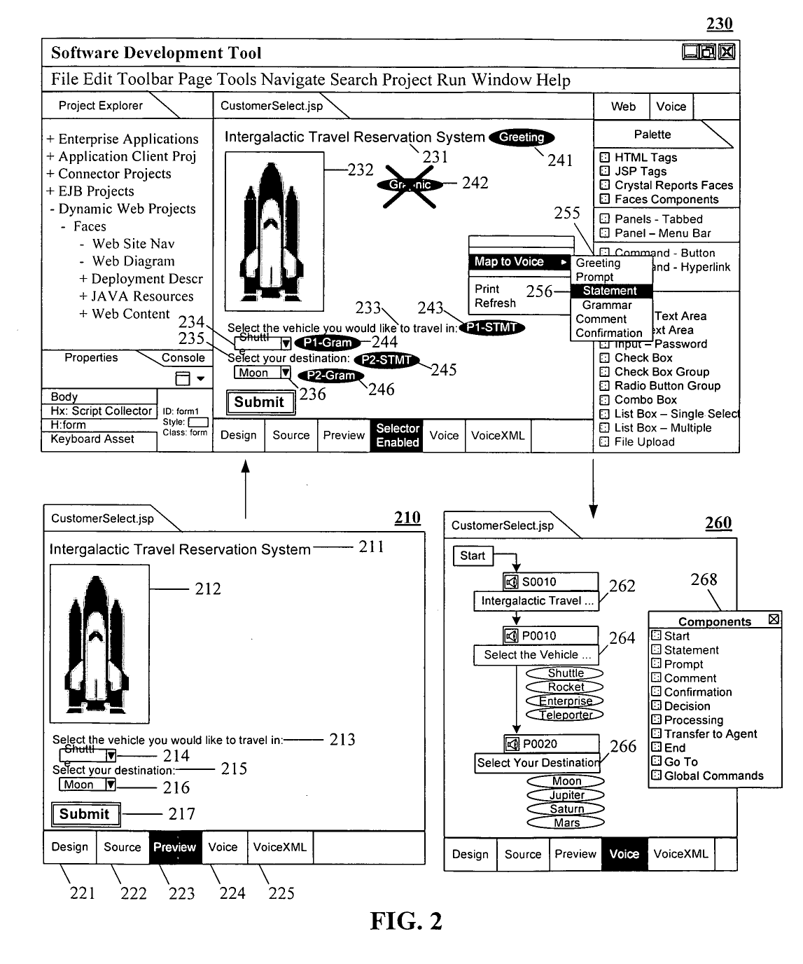

FIG. 2 is a diagram showing graphical user interfaces (GUIs) 210, 230, and 260 of a partially automated software development tool for converting GUI elements into SUI elements in accordance with an embodiment of the inventive arrangements disclosed herein. GUIs 210, 230, and 260 can be implemented in the context of a system 100 or any other system where a visual selector is provided for manually designating a speech control type for SUI elements to be constructed from GUI elements using automated software development tools. In one embodiment, GUIs 210, 230, and 260 can be GUIs integrated into a developer tool, such as RATIONAL JAVA SERVER with FACES tooling. The invention is not to be limited in this regard, and the GUIs 210, 230, 260 can be integrated into any of a variety of other software development tools or software development environments.

GUI 210 can be an integrated component of a software design tool. For example, tabs 221-225 can selectively activate other portions of a software design application. Tab 221 can present a GUI design interface. Tab 222 can provide source code for the visual GUI page. Tab 223 can show a graphical preview of the GUI page. Tab 224 can show generated SUT components. Tab 225 can provide source code for SUI elements and/or GUI elements in a voice-enabled markup language, such as VoiceXML.

GUI 210 shows a visual page having a multiple visual elements 211-217. The visual page does not initially have any speech-enabled elements associated with the visual elements. The speech-enabled elements can be automatically generated with some developer assistance, as described in GUI 230. In GUI 210, element 211 can be associated with a title of “Intergalactic Travel Reservation System.” Element 212 can be associated with a graphic image. Element 213 can be associated with a prompt for selecting a vehicle in which to travel. Element 214 can receive a user input of a travel vehicle. Element 215 can be a prompt for selecting a destination. Element 216 can receive a user input for the destination. Element 217 can apply the user selections.

GUI 230 can show a graphical selector enabled preview for a page that includes visual selectors 241-246, each associated with a graphical element 231-236. Each visual selector 241-246 can have a selector identifier or name as well as a default speech control type. A designer can select a visual selector 241-246, can view a current value for the speech control type 256 within a control selection window 255. Control selection elements can include, but are not limited to, greetings, prompts, statements, grammars, comments, confirmations, and the like.

In GUI 230, a designer can add new visual selectors or delete automatically generated visual selectors that are not desired. For example, if a visual selector 242 is generated for element 232, a designer can manually delete the selector 242. Similarly, if a selector 241 for element 231 including a title is not automatically generated, a designer can manually associate a selector 241 with element 231.

Once a designer has edited GUI 230, the designer can choose to automatically generate SUI elements for each visual selector 241-246. This generation can use a variety of known automated coding techniques, including transcoding, standardized code associated with reusable dialog components, and the like.

GUI 260 shows a SUI development tool that can be utilized to further refine automatically generated SUI elements formed from GUI elements. Specifically, GUI 260 can represent a call flow developer interface. A selection of tools 268 can be used to define a call flow and/or to modify underlying code. The tools 268 can include, for example, developer components of start, statement, prompt, comment, confirmation, decision, processing, transfer to agent, end, go to, and global commands, each selectable from a tool pallet.

The call flow of GUI 260 can include a title 262 for the Intergalactic Travel Reservation System. It can also include a prompt for vehicle selection 264 having grammar choices of shuttle, rocket, enterprise, and teleporter. This grammar can be automatically generated from selectable choices in GUI element 214. GUI 260 can also include a prompt 266 for a destination having grammar choices of Moon, Jupiter, Saturn, and Mars generated from GUI element 216.

It should be appreciated that the arrangements, layout, and control elements for GUIs 210, 220, and 260 have been provided for illustrative purposes only and derivatives and alternates are contemplated herein and are to be considered within the scope of the present invention. For example, the visual selectors 241-246 that are shown as buttons in GUI 230 and that are associated with selectable popup menus can be alternatively implemented in a variety of fashions to achieve approximately equivalent results.

For instance, in one contemplated embodiment (not shown), each visual selector name can appear in a list box having a pull down selection arrow, from which a speech control can be selected. In another embodiment (not shown), a visual selector name can appear as a highlighted text element associated with a fly-over popup window containing user-selectable speech control types. In still another embodiment (not shown), an icon for each visual selector can be presented that can be selected to call up a window from which speech controls and other SUI settings can be chosen.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for constructing speech elements within an interface comprising:
identifying a visual interface having a plurality of visual elements;
presenting visual selectors proximate each of the visual elements, wherein the visual selectors permit a user to input a speech control type for the associated visual element; and
for each presented visual selector, automatically generating a speech element having a speech control type specified in the visual selector.

2. The method of claim 1, further comprising:
automatically detecting the visual elements, wherein the visual selectors are automatically constructed and presented responsive to the detecting step.

3. The method of claim 2, wherein at least a portion of the visual selectors are associated with a user selectable listing of speech control types, wherein each control type in the listing corresponds to a Reusable Dialog Component.

4. The method of claim 1, further comprising:
automatically determining an initial speech control type for each of the visual selectors, wherein the presenting step initially populates the visual selectors with the determined initial speech control type, which the user is able to change.

5. The method of claim 2, further comprising:
before the generating step, permitting a user to selectively modify a number of visual selectors associated with visual elements, wherein the generating step only generates speech elements associated with a visual selector.

6. The method of claim 1, wherein the visual interface is part of a page written in a markup language, wherein said page is not initially speech-enabled, wherein the generating step automatically creates a speech-enabled page written in a markup language.

7. The method of claim 6, wherein the created speech-enabled page is new Web page having a speech user interface.

8. The method of claim 6, further comprising:
automatically detecting a change to at least one of an original page including the visual interface and the created speech-enabled page; and
triggering a synchronization event designed to synchronize the original page and the created speech-enabled page.

9. The method of claim 8, further comprising:
responsive to the triggering step, automatically conveying a notification to a previously designated user associated with at least one of the original page and the created speech-enabled page, said notification indicating the detected change.

10. The method of claim 6, wherein the created speech-enabled page is a multimodal Web page that includes the plurality of visual elements and the speech elements.

11. The method of claim 1, wherein the identifying, presenting, and generated steps are preformed using a graphical software design tool.

12. The method of claim 11, wherein the visual interface is constructed utilizing the software design tool.

13. The method of claim 12, wherein the software design tool includes a call flow design interface within which the automatically generated speech elements are able to be graphically manipulated.

14. The method of claim 1, wherein said steps of claim 1 are performed by at least one machine in accordance with at least one computer program having a plurality of code sections that are executable by the at least one machine.

15. A software development application comprising:
a visual design window for designing visual elements of a visual interface and for automatically generating programmatic instructions associated with designed visual elements;
a selector enabled window configured to graphically display the visual elements, wherein at least a portion of the displayed elements are associated with displayed visual selectors, wherein each visual selector permits a user of the software development application to input a speech control type; and
a SUI element generation engine for automatically generating SUI elements corresponding to each GUI element that is associated with a visual selector, wherein each generated SUI element has a speech control type as specified by the visual selector.

16. The software development application of claim 15, further comprising:
a call flow design interface configured to graphically present a call flow for the automatically generated SUI elements.

17. The software development application of claim 15, wherein each of the speech control types correspond to a Reusable Dialog Component, wherein the Reusable Dialog Component is used to automatically generate programmatic instructions for each of the SUI elements.

18. The software development application of claim 15, wherein the programmatic instructions are written in a markup language renderable by a visual browser and wherein the SUI elements are associated with programmatic instructions written in a speech-enabled markup language renderable by a speech-enabled browser.

19. A graphical user interface comprising:
a window for rendering markup written in a visual markup language;
a plurality of visual selectors graphically rendered in the window that are not specified in the visual markup language, wherein each visual selector corresponds to a visual element displayed in the window, wherein each visual selector permits a user to designate a speech control type, wherein for each visual selector, a speech-enabled element is automatically generated that has the designated speech control type, and wherein automatically generated markup written in a speech-enabled markup language is created for each of the speech-enabled elements.

20. The graphical user interface of claim 19, wherein the graphical user interface is part of a software development application that facilitates the creation of speech-enabled elements from graphical elements using a partially automated technique that converts visual markup to speech-enabled markup, wherein the converting is based partially upon designer specified, pre-generation parameters, which are specified using the visual selectors.
